(19) United States
(12) Patent Application Publication
(10) Pub. No.: US 2010/0192773 A1
(43) Pub. Date: Aug. 5, 2010

(54) ABATEMENT APPARATUS WITH SCRUBBER CONDUIT

(75) Inventors: Daniel O. Clark, Pleasanton, CA (US); Colin John Dickinson, San Jose, CA (US); Jay J. Jung, Sunnyvale, CA (US); Daniel Stephan Brown, Los Gatos, CA (US); Mehran Moalem, Cupertino, CA (US); Frank F. Hooshdaran, Pleasanton, CA (US); Morteza Farnia, Campbell, CA (US); Barry Page, San Jose, CA (US); Gary Sypherd, Glendale, AZ (US); Jonathan Dahm, Austin, TX (US); Phil Chandler, Clifton (GB)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 12/696,808

(22) Filed: Jan. 29, 2010

Related U.S. Application Data
(60) Provisional application No. 61/148,999, filed on Feb. 1, 2009.

(51) Int. Cl. B01D 47/14; B01D 47/12; B01D 47/10; B03C 3/34

(52) U.S. Cl. 96/27; 96/327; 96/325; 96/323; 96/290

(57) ABSTRACT

Embodiments of an abatement apparatus are disclosed herein. In some embodiments, an abatement apparatus may include a scrubber configured to receive an effluent stream from a process chamber and further configured to remove first particles from the effluent stream; a scrubber conduit coupled to the scrubber to receive the effluent stream therefrom and configured to remove second particles from the effluent stream, the scrubber conduit having one or more inlets configured to provide a fluid to sufficiently wet an interior surface of the scrubber conduit to trap the second particles thereon and to wash the second particles therealong; and a central scrubber coupled to the scrubber via the scrubber conduit. In some embodiments, the scrubber conduit is downward sloping from the scrubber to the central scrubber. In some embodiments, a plurality of scrubbers may be coupled to the central scrubber via a plurality of scrubber conduits.

### CROSS-REFERENCE TO RELATED APPLICATIONS

This application claims benefit of U.S. provisional patent application Ser. No. 61/148,999, filed Feb. 1, 2009, which is herein incorporated by reference in its entirety.

### FIELD

Embodiments of the present invention generally relate to abatement apparatus for processing systems.

### BACKGROUND

Abatement apparatus, such as water scrubbers and the like, can be utilized to remove particles from an effluent stream, for amongst other reasons, to meet environmental particulate regulatory emission requirements. Unfortunately, the inventors have observed that conventional scrubbers often fail to adequately remove sub-micron particles from the exhausting effluent stream.

Accordingly, the inventors have provided an abatement apparatus having improved abatement of sub-micron particles.

### SUMMARY

Embodiments of an abatement apparatus having a scrubber conduit are disclosed herein. In some embodiments, an abatement apparatus may include a scrubber configured to receive an effluent stream from a process chamber and further configured to remove first particles from the effluent stream; a scrubber conduit coupled to the scrubber to receive the effluent stream therefrom and configured to remove second particles from the effluent stream, the scrubber conduit having one or more inlets configured to provide a fluid to sufficiently wet an interior surface of the scrubber conduit to trap the second particles thereon and to wash the second particles therealong; and a central scrubber coupled to the scrubber via the scrubber conduit. In some embodiments, the scrubber conduit is downward sloping from the scrubber to the central scrubber. In some embodiments, the scrubber further comprises a plurality of scrubbers and the scrubber conduit further comprises a plurality of scrubber conduits, wherein each scrubber is couple to the central scrubber via one scrubber conduit.

In some embodiments, an abatement apparatus may include a plurality of scrubbers, each configured to receive an effluent stream from one or more of a plurality of process chambers and further configured to remove first particles from the effluent streams; a plurality of scrubber conduits, one each coupled to a corresponding one of the plurality of scrubbers, each scrubber conduit configured to remove second particles from the effluent stream flowing therethrough, each scrubber conduit having one or more inlets configured to provide a fluid to sufficiently wet an interior surface of the scrubber conduit to trap the second particles thereon and to wash the second particles therealong; and a central scrubber coupled to the plurality of scrubbers via the plurality of scrubber conduits, wherein each scrubber conduit has an effluent inlet to receive the effluent stream from a respective scrubber and an effluent outlet to flow the effluent stream to the central scrubber, and wherein the inlet port is at a higher elevation than the outlet port.

Other embodiments and details of the present invention are discussed below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic side view of an abatement apparatus in accordance with some embodiments of the present invention.

FIGS. 2A-C depict schematic side and cross sectional views of a scrubber conduit in accordance with some embodiments of the present invention.

FIG. 3 depicts a schematic side view of an abatement apparatus in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide improved apparatus and methods of conveying effluent, such as effluent streams containing fine particles, water vapor, and exhaust gas species from a Point of Use Scrubber (POU), such as a scrubber coupled to a processing system, such as a process chamber or the like, to a shared local or house scrubber, e.g., a central scrubber. The invention disclosed herein advantageous aides in the removal of sub-micron particles from the effluent stream. Embodiments of the present invention may facilitate, amongst other things, meeting a need for solar factories to meet stringent local environmental particulate regulatory emission requirements. In addition, this novel apparatus may be advantageously employed by any gas company, chemical company, oil company, medical, fine dust transfer and storage management, bio and bio pharmaceutical company, nano-technology, LCD, OLED, film, or electronic manufacturing company or other application where a point of use scrubber is backed up by a shared facility or localized shared scrubber.

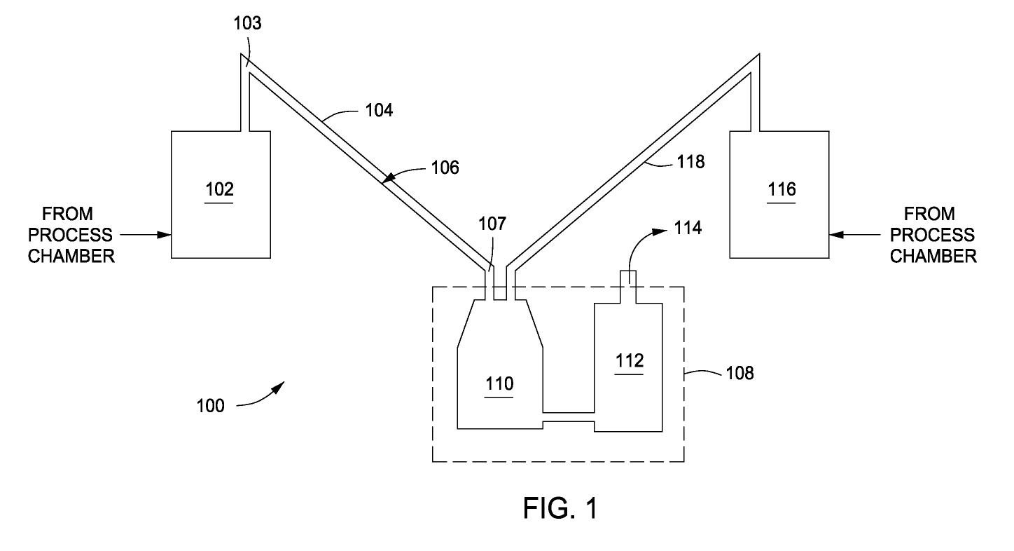

FIG. 1 depicts an abatement apparatus in accordance with some embodiments of the present invention. The abatement apparatus 100 includes a scrubber 102 coupled to a central scrubber 108 via a scrubber conduit 104. The scrubber 102 is configured to receive an effluent stream from one or more process chambers and to remove first particles from the effluent stream flowing therethrough. The effluent stream may be an effluent stream from one or more process chambers that provide an effluent needing abatement. Non-limiting examples of such process chambers include substrate processing systems used in, for example, semiconductor, flat panel, photovoltaic or other silicon and thin film processing applications. One exemplary application may be in a Sun Fab tool, available from Applied Materials, Inc., of Santa Clara, Calif., which comprises seven Plasma Enhanced Physical Vapor Deposition (PECVD) chambers, each connected to an abatement system, such as a Marathon Solar Abatement system, also available from Applied Materials, Inc.

The scrubber 102 may be a POU scrubber or any suitable scrubber for processing an effluent stream to remove particles, such as SiO₂ particles or the like. For example, and in some embodiments, the scrubber 102 may be part of an abatement system, such as the Marathon abatement system, available from Applied Materials, Inc. For example, in some embodiments, a thermal abatement system, such as the Marathon, may form SiO₂ particles when abating certain process effluent. The SiO₂ particles are entrained in the effluent stream and, in conventional systems, may undesirably be exhausted to the environment or collect in downstream effluent handling equipment. Alternatively, or in combination, SiO₂ particles may be formed in a process chamber or similar apparatus from which the effluent stream is generated. For example, such process chambers could include any chamber that deposits silicon or other crystalline or microcrystalline compounds, for example, in LCD, Solar, OLED, or other silicon substrate processing applications.

The apparatus 100 further includes a scrubber conduit 104 coupled to the scrubber 102 to receive the effluent stream from the scrubber 102 and to remove second particles from the effluent stream as it flows through the scrubber conduit 104. The scrubber conduit 104 includes an effluent inlet 103 for receiving the effluent stream from the scrubber 102 and an effluent outlet 107 for flowing the effluent stream to the central scrubber 108. The second particles removed by the scrubber conduit 104 may be smaller than the first particles removed by scrubber 102. For example, the second particles may include sub-micron particles. Alternatively, or in combination, the second particles may include particles of similar size to the first particles, e.g., micron-sized particles or greater, that were not removed by the scrubber 102. The second particles can be scrubbed by allowing them to condensate, nucleate, and grow, for example on wetted interior surfaces of the scrubber conduit, as they pass through the scrubber conduit 104, eventually achieving sufficient size to make them easy to remove by more conventional water scrubbing means, such as the central scrubber 108 discussed below.

The inventors have discovered that ultra fine (between about 0.01 to about 1.0 micron) particles, for example silicon oxide (SiO₂) particles, condense on cool water wetted surfaces. This ability to trap sub micron particles on a water wetted cold surface is unique, and is a result of a different mechanism than that employed in, for example packed bed water scrubbers, such as utilized in the Marathon abatement system, available from Applied Materials, Inc. As such, the scrubber conduit 104 may advantageously capture additional, and smaller, particles from the effluent stream that are not captured by conventional scrubbers (which can scrub particles that are generally greater than 1 micron in size, but which are very inefficient at scrubbing particles under 1 micron).

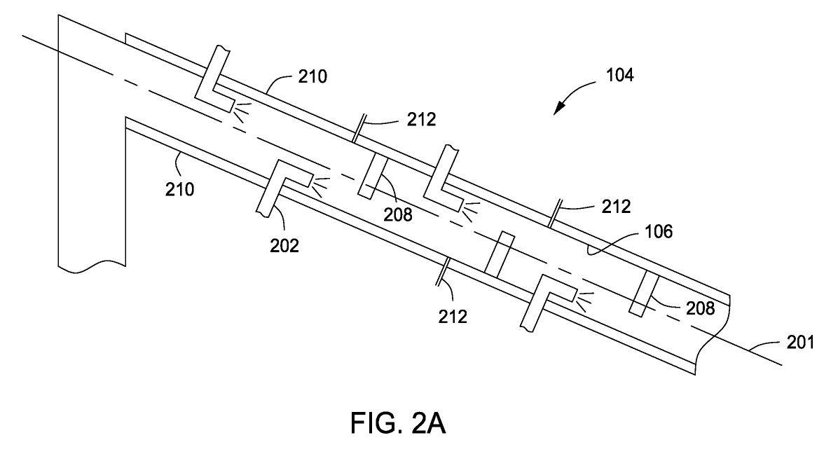

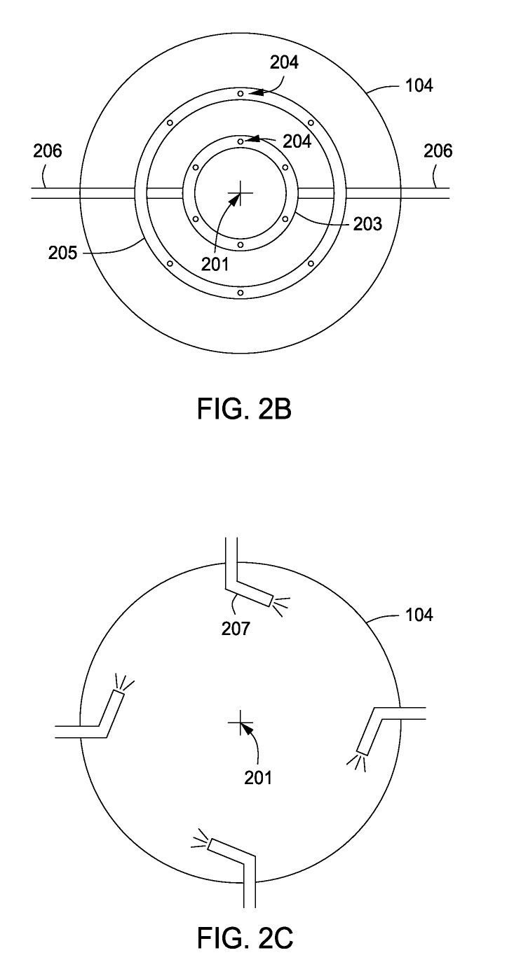

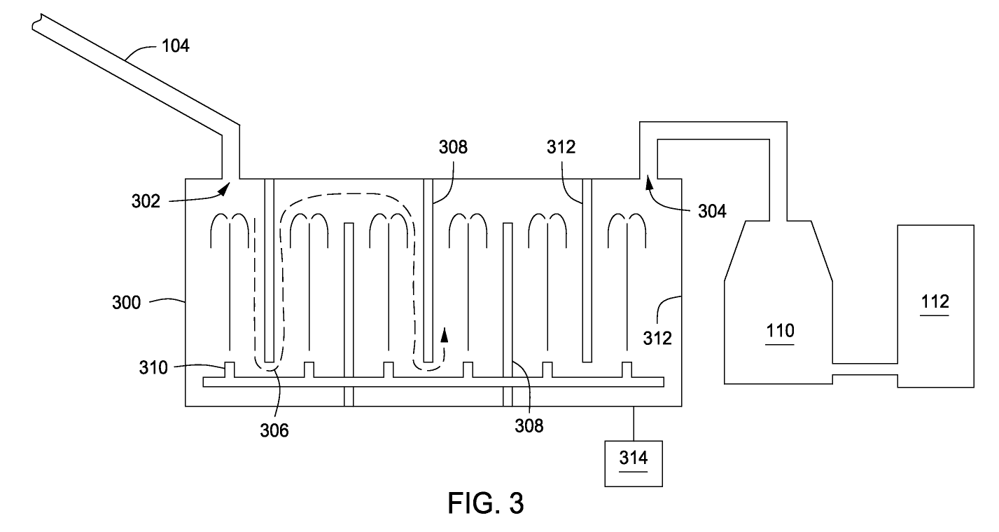

The scrubber conduit 104 includes one or more inlets (inlets 202, illustrated in FIG. 2A) configured to provide a fluid to sufficiently wet an interior surface 106 of the scrubber conduit 104 to trap the second particle thereon and wash the second particles therealong. The sub-atmospheric pressure scrubber conduit thus acts as a water wetted cold trap, causing fine particles to condense on its surface. The particles may be washed downstream by the condensed volume of water or scrubbing fluid. In some embodiments, the effluent inlet 103 is at a higher elevation than the effluent outlet 107. For example, in some embodiments, the scrubber conduit 104 can be downward sloping (as shown) from the scrubber 102 to a central scrubber 108 or another apparatus, such as a scrubber module depicted in FIG. 3, discussed below. The downward slope of the scrubber conduit 102 can advantageously facilitate the washing of the second population of particles from the interior surface 106 of the scrubber conduit 104 and into the central scrubber 108 (or a scrubber module as discussed with respect to FIG. 3 below). The scrubber conduit 104 need not be linear along the entirety of its length (as shown), and other suitable configuration may include sections of the conduit which can be upward sloping while still maintaining a general downward flow between the effluent inlet 103 and effluent outlet 107. In some embodiments, the house exhaust system coupled to individual point of use scrubbers may be modified to form the scrubber conduit as described herein and may further be coupled to a central scrubber as described herein, thereby advantageously implementing embodiments of the present invention in a cost- and space-effective manner.

The central scrubber 108 may include a Venturi water scrubber, a spray tower, a cloud chamber, an electrostatic precipitator or a packed bed water scrubber, or other suitable house scrubber systems. In some embodiments, the central scrubber 108 may include a Venturi scrubber 110 coupled to the scrubber conduit 104 and a particle agglomeration module 112 coupled to the Venturi scrubber 110. The particle agglomeration module 112 may facilitate further agglomeration and collection of particles in the effluent stream.

In some embodiments, the central scrubber 108 receives the effluent stream and the trapped second particles from the scrubber conduit 104, and further processes the effluent stream to remove third particles therefrom. The third particles may include particles of a smaller dimension or similar dimension as either or both of the first and second particles. From the central scrubber 108, the effluent stream may be released into the environment (as shown at exhaust 114) or forwarded to additional abatement apparatus for further processing, as required, for example, to meet applicable legal standards.

In some embodiments, the apparatus 100 may include a plurality of scrubbers and plurality of scrubber conduits, wherein each scrubber is coupled to the central scrubber 108 via a respective scrubber conduit. For example, and as illustrated in FIG. 1, a second scrubber 116 may be coupled to the central scrubber 108 (or Venturi scrubber 110 as shown) via a second scrubber conduit 118. The second scrubber 116 and the second scrubber conduit 118 may be substantially similar to the scrubber 102 and scrubber conduit 104, respectively. Alternatively, the second scrubber 116 and second scrubber conduit 118 may be configured differently depending on the identity of the effluent stream flowing therethrough. For example, the scrubber 102 and the second scrubber 116 may receive effluents from different process chambers necessitating a different configuration. Further, the apparatus 100 is not limited to two scrubbers and two scrubber conduits, and may be utilized with any suitable number of scrubbers and scrubber conduits as can be adequately supported by the central scrubber 108.

FIGS. 2A-C depict schematic side and cross-sectional views of the scrubber conduit 104 in further detail and in accordance with some embodiments of the present invention. As discussed above, the scrubber conduit 104 can be downward sloping to facilitate the washing of second particles trapped on the interior surface 106 into the central scrubber 108 or the scrubber module depicted in FIG. 3.

The scrubber conduit 104 includes a central axis 201. One or more inlets 202 may be disposed along the length of the central axis 201 in any of a number of suitable configurations to provide a fluid to wet the inner surfaces 106 of the scrubber conduit 104. In some embodiments, the one or more inlets may be spray jets, for example, to form ultra fine mist or water droplets.

In some embodiments, the one or more inlets 202 may be disposed concentrically about the central axis 201, for example, as shown by concentric spray jets 203, 205 in FIG. 2A. Although two concentric spray jets 203, 205 are depicted in FIG. 2A, one or more concentric spray jets may be used. The concentric spray jets may be circular, or other suitably shaped, conduits having a plurality of openings 204 to spray fluid into the scrubber conduit 104. One or more inlet conduits 206 may be used to support and position the concentric spray jets within the scrubber conduit and to couple the concentric spray jets to a suitable fluid source, such as a factory water supply. In some embodiments, the concentric spray jets 203, 205 may be oriented to spray fluid in a downstream direction towards the central scrubber 108 to facilitate the washing of second particles from the interior surfaces 106 into the central scrubber 108 and/or facilitate movement of the effluent stream toward the central scrubber 108.

Alternatively, or in combination with the concentric spray jets, one or more spray jets may be oriented tangentially about the scrubber conduit 104, for example, such as spray jets 207 depicted in FIG. 2C. The tangential, or non-radially aligned, spray jets 207 may be configured to facilitate swirling the effluent stream, which may cause second particles to be directed towards the interior surfaces 106 (and increase impaction thereagainst) due to centripetal forces developed by swirling effluent stream.

Returning to FIG. 2A, the scrubber conduit 104 can include one or more baffles 208 to improve mixing and the spray jets can assist in keeping the baffles clear by washing off condensed particles. The baffles 208 can further increase the surface area of the interior surface 106 on which second particles from the effluent stream can condense or trap. Further, the baffles 208 may create a torturous path resulting in increased residence time in the scrubber conduit 104. Although baffles 208 are depicted in FIG. 2A, the baffles 208 may be used in any of the embodiments scrubber conduits disclosed herein.

For example, the time that second particles spend in the scrubber conduit 104 may be longer than the time that these particles spend in the other abatement devices, such as the scrubber 102 by about 2 to about 100 times. By further utilizing the baffles 208 to increase the path length of the effluent stream through the scrubber conduit 104, which is already much longer than the path length through the abatement device, improved removal of the second particles by the scrubber conduit 104 may be achieved.

Further, the volume and/or length scrubber conduit, the number of baffles 208, or the like can be modified to increase the residence time of the effluent stream within the conduit 104 to allow for condensation, nucleation, or agglomeration to form larger cohesive particles which can be more easily scrubbed, for example, in the central scrubber 108.

In some embodiments, one or more air dryer injection inlets 212 may be provided to manage dew point and flammables safety in the scrubber conduit 104 in any of the embodiments discussed herein. Dry air additions can be made at various points in the scrubber conduit 104 (three locations illustratively shown in FIG. 2A) to minimize the chance of condensable materials becoming liquid while in the scrubber conduit 104 in locations where condensation is undesirable. Embodiments of the present invention may add additional volumes of dry air or inert gas to assure maintaining gas compositions safely below lower flammable and lower explosive composition limits.

In some embodiments, the scrubber conduit 104 may include insulation 210 wrapped around the exterior of the conduit 104. The insulation 210 may be utilized to maintain the interior surfaces 106 at a lower temperature than the effluent stream such that optimal condensation or trapping of second particles along the wetted interior surfaces 106 can be achieved. In some embodiments, cooling conduits (not shown) may be disposed about the scrubber conduit 104, optionally within the insulation 210, to flow a heat transfer fluid to cool the scrubber conduit 104. Typically, the temperatures of the interior surfaces 106 may be maintained at temperatures lower than the effluent stream but not below freezing temperatures, (e.g., about zero degrees Celsius). The lower temperatures of the interior surfaces 106 can encourage condensation, nucleation, and growth of the second particles.

The fluid supplied by the one or more inlets 202 of the scrubber conduits 104 can include water (H₂O) or any other medium of sufficient surface energy to encourage condensation and particulate growth. Further, and in some embodiments, the fluid may include one or more chemical additives to increase the affinity of the mist for the second particles. For example, an additive could include an ionic water soluble polymer such as an anionic or cationic flocculating agent, a caustic, or a salt. The fluid containing chemical additives can be washed forward into the central scrubber 108 (or the scrubber module 300 as depicted in FIG. 3 and described below) where it will increase the particle scrubbing efficiency of the central scrubber 108 (or scrubber module 300).

FIG. 3 depicts a schematic example of a fine particle scrubber module 300 that could optionally be placed in the path of the scrubber conduit 104 and utilized for further particle removal from the effluent stream. Although only one scrubber module 300 is illustrated, the apparatus 100 can include a plurality of scrubber modules 300, each scrubber module placed in the path of each scrubber conduit 104.

The scrubber module 300 may be disposed between the scrubber conduit 104 and the central scrubber 108. The scrubber module 300 includes an inlet 302 for receiving the effluent stream and trapped second particles from the scrubber conduit 104 and an outlet 304 for exhausting the effluent stream to the central scrubber 108. The inlet and the outlet of the scrubber module 300 are separated by a torturous path 306 for flowing the effluent stream therethrough. The torturous path 306 may be utilized to increase residence time of the effluent stream flowing through the scrubber module 300.

The module 300 has one or more baffles 308 or other elements providing an increased path length for gases flowing through the module. For example, the baffles 308 can be utilized to create the torturous path 306 between the inlet 302 and outlet 304. Utilization of the tortuous path 306 advantageously enables a long effective “wet pipe” length housed in a compact design. In the embodiment shown in FIG. 3, the baffles 308 define a zig-zag path through the module 300. However, other flow paths may be provided as well.

One or more spray heads 310 may be disposed within the module 300 or otherwise configured to provide a water spray along the torturous path 306. The spray heads may provide a fluid in the form of a fountain-like spray within one or more portions of the torturous path 306. The fountain-like spray heads 310 provide mixing of the fluid (or the fluid and one or more chemical additives as discussed above) and third particles in the effluent stream. Fluid droplets act as impaction surfaces for the third particles. For example, the third particles may be of lesser or equal dimension than either or both of the first and second particles. Flowing vertically upwards and descending by gravity improves residence time of fluid droplets compared to a traditional spray tower spraying fluid from above. The increased fluid droplet residence time and high fluid flow can be combined to maximize fluid droplet density within the scrubber module 300 to maximize the probability of particle impaction into the fluid droplet. Further, the effluent stream can flow both concurrent and countercurrent to the direct of fluid provided by the one or more fountain spray heads 310 as the effluent stream travels along the tortuous path 306 of the scrubber module 300.

Similar to the scrubber conduit 104 discussed above, the fluid can further wet an interior surface 312 of the scrubber module 300 along the torturous path 306 to trap or condense the third particles thereon and wash the third particles therefrom. In some embodiments, a collection sump 314 may be coupled to the scrubber module 300 to facilitate collection of the third particles (and second particles entering from the scrubber conduit 104 at the inlet 302). Further, the scrubber module 300 may be insulated or cooled as discussed above to maintain the interior surfaces 312 at temperatures below that of the effluent stream to aid in condensation of the particles on the interior surfaces 312. The effluent stream may exit the torturous path 306 at the outlet 304 and proceed to the central scrubber 108 for further processing.

Embodiments of the present invention provide improved apparatus and methods of conveying effluent, such as effluents containing fine particles, water vapor, and exhaust gas species from a Point of Use Scrubber (POU), such as a scrubber coupled to a processing system, such as a process chamber or the like, to a shared local or house scrubber, e.g., a central scrubber. The invention disclosed herein advantageously aids in the removal of sub-micron particles from the effluent stream.

Further, the invention disclosed herein can provide additional benefits, such as by providing fluid into the scrubber conduit to dilute any potential acid content of the effluent stream, which can aid reducing corrosion in the scrubber conduit. Further, if a basic chemical additive were used to improve fine particle affinity to fluid droplets and the water surface film on the interior surfaces 106 of the scrubber conduit 104, that basic additive can also help control the pH of acidic gases in the effluent stream, for example such as acidic gases used to clean process chambers.

Further, flammability safety is also improved as a fire requires a oxidizer, fuel, and heat. A fine water mist as supplied by the scrubber conduit is able to dissipate thermal energy that could be an ignition source and the fine mist would greatly reduce the chance of static charge build up.

Thus, the inventive apparatus disclosed herein can have further benefits that help keep the scrubber conduits clean and greatly reduces the need for exhaust system Preventative Maintenance (PM) activities by diluting and washing corrosive species and fine particles forward to the central scrubber.

While the foregoing is directed to embodiments of the present invention, other and further embodiments of the invention may be devised without departing from the basic scope thereof.

1. An abatement apparatus, comprising:
a scrubber configured to receive an effluent stream from a process chamber and further configured to remove first particles from the effluent stream;
a scrubber conduit coupled to the scrubber to receive the effluent stream therefrom and configured to remove second particles from the effluent stream, the scrubber conduit having one or more inlets configured to provide a fluid to sufficiently wet an interior surface of the scrubber conduit to trap the second particles thereon and to wash the second particles therealong; and
a central scrubber coupled to the scrubber via the scrubber conduit.

2. The apparatus of claim 1, wherein the scrubber further comprises a plurality of scrubbers and the scrubber conduit further comprises a plurality of scrubber conduits, wherein each scrubber is coupled to the central scrubber via a respective scrubber conduit.

3. The apparatus of claim 1, wherein the scrubber conduit is downward sloping from the scrubber to the central scrubber.

4. The apparatus of claim 1, further comprising:
an effluent inlet to receive the effluent stream from the scrubber; and
an effluent outlet to flow the effluent stream to the central scrubber, wherein the inlet port is at a higher elevation than the outlet port.

5. The abatement apparatus of claim 1, wherein the one or more inlets of the scrubber conduit further comprise one or more spray jets to spray the fluid.

6. The abatement apparatus of claim 5, wherein the one or more spray jets are disposed within the scrubber conduit and are further disposed concentrically about a central axis of the scrubber conduit.

7. The abatement apparatus of claim 6, wherein the one or more spray jets are oriented to spray the fluid in a downstream direction from the scrubber to the central scrubber.

8. The abatement apparatus of claim 6, wherein the one or more spray jets are disposed proximate a sidewall of the scrubber conduit and are oriented to spray the fluid in a direction substantially tangential to the scrubber conduit.

9. The abatement apparatus of claim 8, wherein the one or more spray jets are further oriented to spray the fluid in a downstream direction from the scrubber to the central scrubber.

10. The abatement apparatus of claim 3, further comprising a fluid source coupled to the one or more inlets, wherein the fluid comprises water.

11. The abatement apparatus of claim 10, wherein the fluid further comprises a water soluble anionic flocculating polymer, a water soluble cationic flocculating polymer, a caustic, or a salt.

12. The abatement apparatus of claim 1, wherein the scrubber conduit further comprises:
insulation disposed about the exterior of the scrubber conduit.

13. The abatement apparatus of claim 1, wherein the scrubber conduit further comprises:
one or more baffles dispose therein, wherein the one or more baffles partially form the interior surface of the scrubber conduit.

14. The abatement apparatus of claim 1, wherein the central scrubber comprises a Venturi scrubber, a spray tower, a cloud chamber, an electrostatic precipitator, or a packed bed water scrubber.

15. The abatement apparatus of claim 1, wherein central scrubber comprises:
a Venturi scrubber coupled to the scrubber conduit; and
a particle agglomeration module coupled to the Venturi scrubber.

16. The abatement apparatus of claim 1, further comprising:
a scrubber module disposed between the scrubber conduit and the central scrubber, the scrubber module having an inlet for receiving the effluent stream and trapped second particles from the scrubber conduit and an outlet for exhausting the effluent stream to the central scrubber, wherein the inlet and the outlet are separated by a torturous path for flowing the effluent stream therethrough.

17. The abatement apparatus of claim 16, wherein the scrubber module further comprises:
one or more fountain spray heads for spraying a second fluid for removing third particles from the effluent stream.

18. The abatement apparatus of claim 17, wherein the fountain spray head are configured to spray the second fluid sufficient to wet an interior surface of the scrubber module along the torturous path to trap the third particles thereon and wash the third particles therefrom.

19. The abatement apparatus of claim 17, wherein each scrubber module further comprises:
a collection sump for collecting the second fluid and the second and third particles.

20. The abatement apparatus of claim 16, wherein each scrubber module further comprises:
one or more baffles that form the torturous path between the inlet and outlet of the scrubber module.

21. An abatement apparatus, comprising:
a plurality of scrubbers, each configured to receive an effluent stream from one or more of a plurality of process chambers and further configured to remove first particles from the effluent streams;
a plurality of scrubber conduits, one each coupled to a corresponding one of the plurality of scrubbers, each scrubber conduit configured to remove second particles from the effluent stream flowing therethrough, each scrubber conduit having one or more inlets configured to provide a fluid to sufficiently wet an interior surface of the scrubber conduit to trap the second particles thereon and to wash the second particles therealong; and
a central scrubber coupled to the plurality of scrubbers via the plurality of scrubber conduits, wherein each scrubber conduit has an effluent inlet to receive the effluent stream from a respective scrubber and an effluent outlet to flow the effluent stream to the central scrubber, and wherein the inlet port is at a higher elevation than the outlet port.
